(19) United States
(12) Patent Application Publication
(10) Pub. No.: US 2016/0306868 A1
(43) Pub. Date: Oct. 20, 2016

(54) MULTI-LEVEL DATABASE SEARCHING

(71) Applicant: Microsoft Technology Licensing, LLC, Redmond, WA (US)

(72) Inventors: Michael Aksionkin, Kirkland, WA (US); Oren Ryngler, Snohomish, WA (US)

(21) Appl. No.: 14/825,590

(22) Filed: Aug. 13, 2015

Related U.S. Application Data
(60) Provisional application No. 62/147,251, filed on Apr. 14, 2015.

(51) Int. Cl. G06F 17/30

(52) U.S. Cl. CPC G06F 17/30587; G06F 17/30477; G06F 17/3053

(57) ABSTRACT

A computer system that provides search functionality relative to people in an organization includes a processor and a data store containing profile information relative to the people in the organization. A query processing engine is coupled to the processor and is configured to execute queries against the data store. The processor is configured to receive user input information indicative of a name and responsively generate a first query. The query processing engine is configured to execute the first query against only a name field relative to the profile information and return a first query result. The query processing engine is configured to selectively, automatically execute a second query against at least one additional field of the profile information if the first query result is empty, and return second query results.

### CROSS-REFERENCE TO RELATED APPLICATION

The present application is based on and claims the benefit of U.S. provisional patent application Ser. No. 62/147,251, filed Apr. 14, 2015, the content of which is hereby incorporated by reference in its entirety.

### BACKGROUND

In many situations, it is desirable to find and contact a person. Typically, this is done by consulting a directory or listing of people. However, as the number of people grows, and aspects or characteristics of people in the search space become relevant to the search, the process becomes more difficult. Generally, such searches are conducted using computers. When a user enters a person's name or other information, such as job title, department, et cetera into a search box of a user interface, a query will be generated with the name to a data store having information about all of the people in the search space. The query results are then generally provided to the user in a ranking based on the degree to which the individual result matches the query.

The discussion above is merely provided for general background information and is not intended to be used as an aid in determining the scope of the claimed subject matter.

### SUMMARY

A computer system that provides search functionality relative to people in an organization includes a processor and a data store containing profile information relative to the people in the organization. A query processing engine is coupled to the processor and is configured to execute queries against the data store. The processor is configured to receive user input information indicative of a name and responsively generate a first query. The query processing engine is configured to execute the first query against only a name field relative to the profile information and return a first query result. The query processing engine is configured to selectively, automatically execute a second query against at least one additional field of the profile information if the first query result is empty, and return second query results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a computing environment where a user may implement a computer-assisted search for people in accordance with one embodiment.

FIG. 2 is a diagrammatic view of a user profile with which embodiments described herein are particularly useful.

FIG. 3 is a flow diagram of a computer-implemented method of searching for people in a data store in accordance with one embodiment.

FIG. 4 is a block diagram of the architecture, shown in FIG. 1, except that its elements are disposed in a cloud computing architecture.

FIG. 5 provides a general block diagram of the components of a client device that can run components of system 102 or that interacts with system 100, in accordance with one embodiment.

FIG. 6 shows one embodiment in which a user device is a tablet computer.

FIG. 7 shows one embodiment in which a user device is a smart phone.

FIG. 8 shows one embodiment of a computing environment in which a computing system, or parts of it, (for example) can be deployed.

### DETAILED DESCRIPTION

A computer system and method are provided that improve searches for people in a data store. In one embodiment, a query is first executed against only a full name field of the data store. If no matches are found, the query is executed again against additional fields in the data store. In one embodiment, if no matches are found after the second query, a subsequent query against additional fields may be performed. Different methods of ranking search results are also provided.

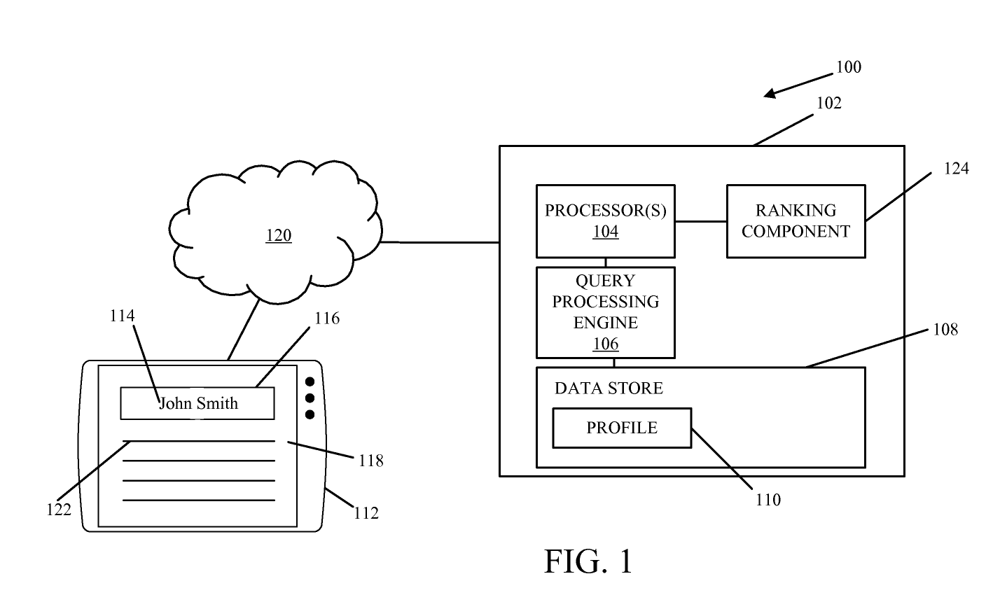

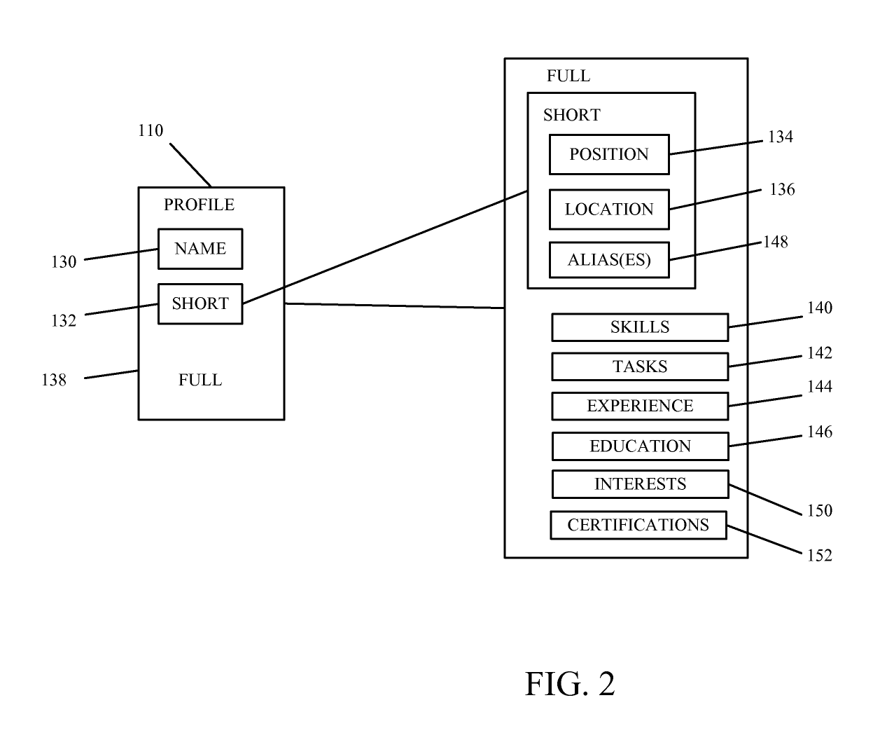

FIG. 1 is a diagrammatic view of a computing environment where a user may perform a computer-assisted search for people in accordance with one embodiment. Environment 100 includes computing system 102 which may be a server or other suitable device. Computing system 102 includes one or more processors 104 coupled to a query processing engine 106. Query processing engine 106 is configured to receive queries relative to a person's name and execute such queries against data store 108 and provide query results to the requester. Data store 108 includes profile information 110 relative to a plurality of people. This profile information, (which will be described in greater detail with respect to FIG. 2) generally includes each person's name as well as any other suitable information relative to that person. In order to locate a particular person, a user typically uses device 112 and enters a person's name 114, position, or other profile details, or combination thereof into search box 116 of user interface 118. User device 112 couples to computing system 102 via communication network 120, which may be any suitable local area network, wide area network, or combination thereof and provides name 114 to query processing engine 106. Once computing system 102 receives name information 114 from user device 112, query processing engine 106 generates a query against data store 108 in order to attempt to locate one or more matches to the query input. The query results 122 are provided by query processing engine 106 to user device 112, which are generally ranked by ranking component 124.

The manner in which the query results are ranked is provided by ranking component 124 of computing system 102. Instead of ranking the query results based on the degree to which the results match the name information 114 provided to computing system 102, other aspects of the people in the search space can be used to rank the results. Further, in embodiments where the user of device 112 is logged into system 102, certain characteristics and information about the user can be used by ranking component 124 to provide the ranking. For example, if a particular user is based in a particular city or state, search results of people who are also based in the same city or state may have a higher ranking than individuals in other cities or states. Further still, in corporate settings, the proximity of the user performing the search to the individuals in the search results on an organizational chart may be used by ranking component 124 to rank the results. Of course, other characteristics of the user as well as the people in the search space, as well as any combinations thereof can be used by ranking component 124 to rank results 122.

FIG. 2 is a diagrammatic view of a user profile with which embodiments described herein are particularly useful. User profile 110 is one example of a person's record that is stored in data store 108. User profile 110 generally includes a full name field 130. Some frequently used full profile fields contain a short version of a person's profile (short profile). In the example shown in FIG. 2, the information in the short profile field is different from that in the full profile field, but it is contemplated that the full profile field can entirely encompass the short profile. In the example shown in FIG. 2, the short profile field 132 includes position information 134 relative to the person, such as the person's job title or role within an organization. Additionally, the location 136 of the person is also provided in the short profile. This location can include the city, state, and country where the person is based. Further, the location can include any other geographic information that specifies the user's location including a facility name, geographic coordinates, et cetera. Further still, short profile information 132 can include one or more aliases or nicknames 148 of the individual. This is particularly useful in the context of searching for people in that nicknames or aliases are very common.

Full profile 138 includes all remaining information relative to the individual. In the context of a corporation, this can be all information that is potentially relevant to an individual and may be of use during a search. For example, such information includes individual skills 140 of the individual. For example, skills such as troubleshooting, programming in a particular language, et cetera may be stored in skill field 140. Additionally, various tasks or projects 142 that the individual has worked with or completed may be relevant to the search. Additionally, full profile 138 may also include the number of work experience records including company and external 144 that the individual had. Additionally, full profile 138 may include one or more interests 150 of the individual, such as hobbies, et cetera. Further still, full profile information 138 may include one or more certifications 152 completed by the individual. These are simply examples of the various parameters of an individual that may be relevant within an organization for a people search. Any of the information provided in short profile 132, and/or full profile 138 can be used by ranking component 124 to rank the query results, as desired. Additionally, in one embodiment, the user of device 112 may specify the type of ranking when submitting name information 114.

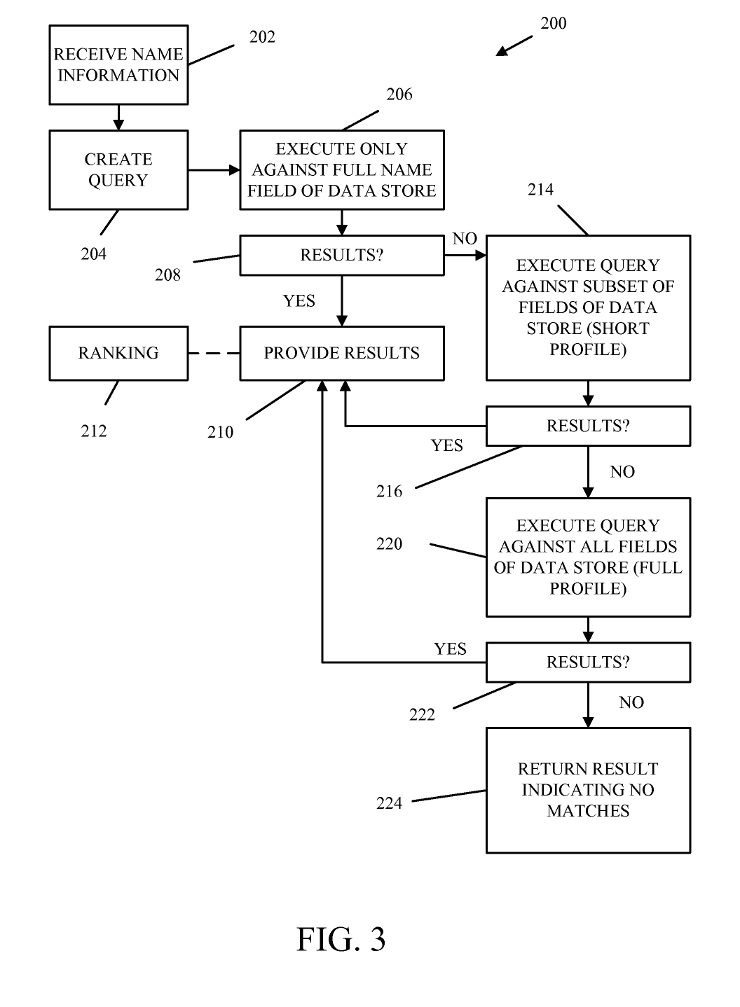

FIG. 3 is a flow diagram of a computer-implemented method of searching for people in a data store in accordance with one embodiment. Method 200 begins at block 202 where name information is received. In one example, this name information is received by a user device, such as user device 112 and communicated to a computing system, such as computing system 102. Next, at block 204, a query is generated based on the received name information. The query is then executed against only the full name field within the data store containing the person information. This is indicated at reference numeral 206. The initial execution of the query against only the full name field is highly efficient in that the query results can be provided very quickly if there is one or more matches. This speed is particularly useful in embodiments where method 200 executes with each keystroke of information provided by the user. For example, as a user begins to type the name John Smith, method 200 may be executing upon completion of each keystroke. In other examples, method 200 may execute only when the user has completed entering the name information. If block 208 determines that there are search results, the search results are provided to the user as indicated at block 210. The provision of the search results may optionally be ranked, as indicated at block 212 by a suitable ranking component, such as ranking component 124. As set forth above, the ranking can be based on other information relative to the people listed in the data store. For example, the proximity of the user submitting the name information to the search result on an organizational chart may be used to rank the search results. Accordingly, people close to the user in the organizational hierarchy may be listed higher than those that are farther away. In an organization with thousands or hundreds of thousands of employees or members, this ranking may be highly useful.

Returning to block 208, if no results are provided when the query is executed only against the full name field, the query is executed again against a subset of fields in the user data store. For example, the subset of field may be a short profile of users including such information as job title and/or geographic location. This second execution of the query against a subset of fields is indicated diagrammatically at reference numeral 214. Next, block 216 determines if there are any search results to the executed second query. If so, control passes to block 210 where the results are provided to the user and optionally ranked, as indicated at block 212. If no results are generated as a result of the second query, the query is next executed against the full set of fields in the user data store, as indicated at reference numeral 220. Once the query indicated in reference numeral 220 is executed, block 222 determines if there are any results. If so, control passes to block 210, as set forth above. If not, control passes to block 224 and the user is informed that there are no matches to the user input.

This multi-level approach to people searching is amenable to efficient application with search-as-you-type technologies, and also highly useful for providing relevant rankings of people found during the search.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

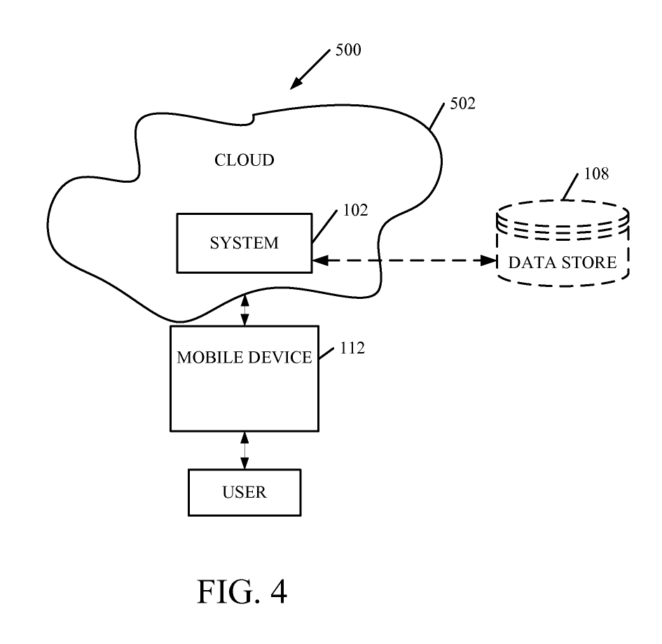

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

FIG. 4 also depicts another embodiment of a cloud architecture. FIG. 4 shows that it is also contemplated that some elements of computing system 102 are disposed in cloud 502 while others are not. By way of example, data store 108 can be disposed outside of cloud 502, and accessed through cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

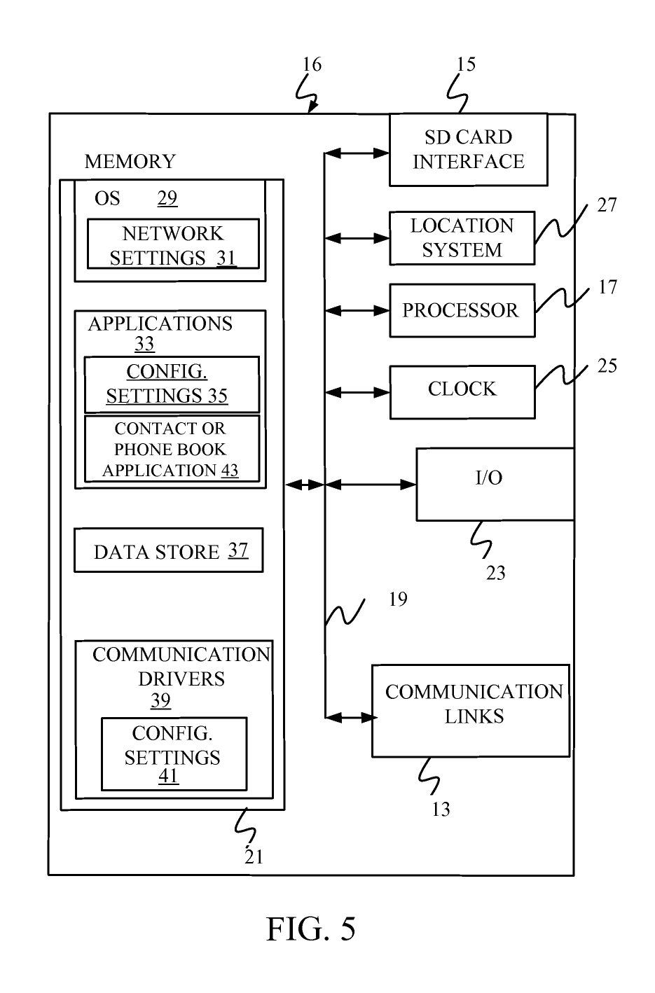

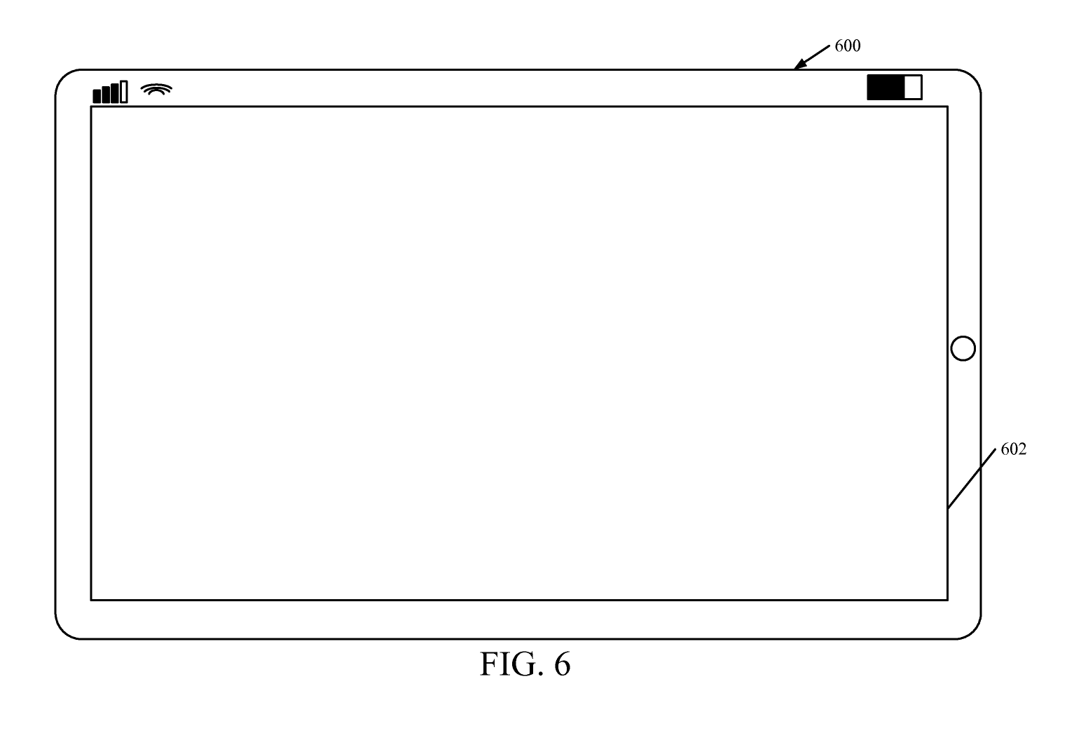

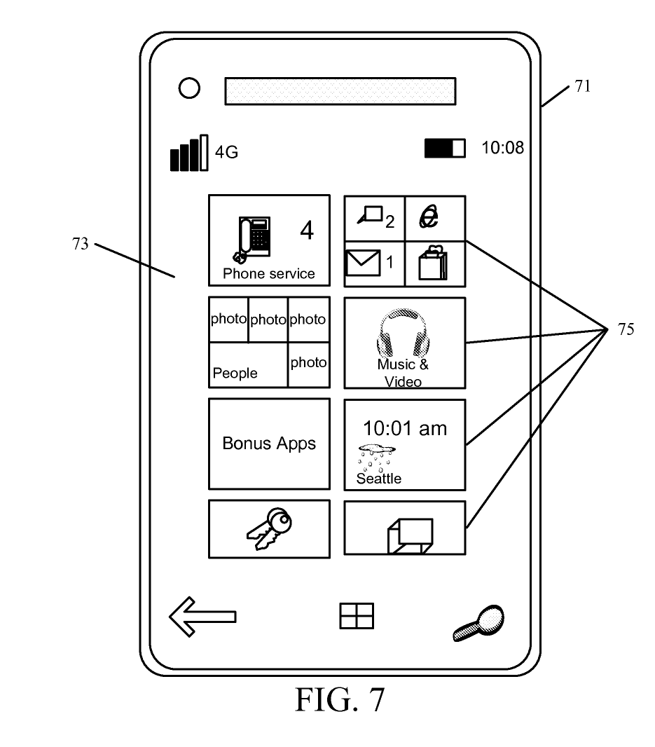

FIG. 5 is a simplified block diagram of one illustrative embodiment of a handheld or mobile computing device that can be used as a user's or client's hand held device 16, in which the present system (or parts of it) can be deployed. FIGS. 6 and 7 are examples of handheld or mobile devices.

FIG. 5 provides a general block diagram of the components of a client device 16 that can run components of system 102 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. The items in data store 108, for example, can reside in memory 21. Similarly, device 16 can include any or all of computing system 102.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 7 provides an additional example of device 16 that can be used, although others can be used as well. In FIG. 7, a smart phone 71 is provided. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

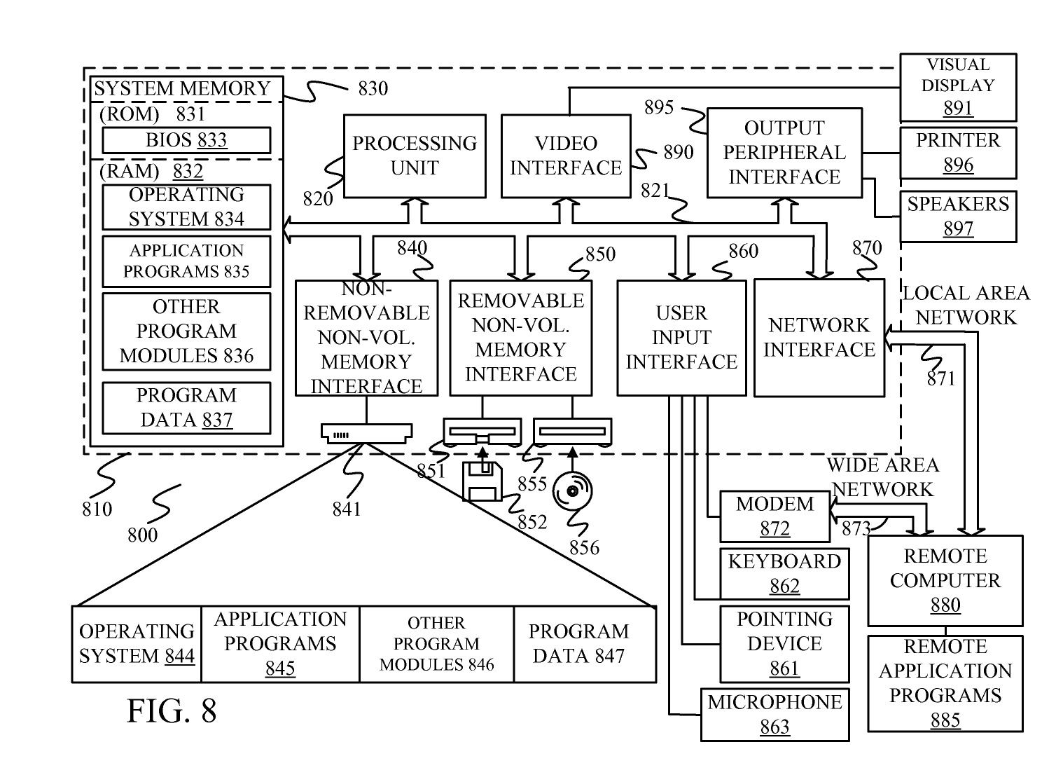

FIG. 8 is one embodiment of a computing environment in which computing system 102, or parts of it, (for example) can be deployed. With reference to FIG. 8, an exemplary system for implementing some embodiments includes a general-purpose computing device in the form of a computer 810. Components of computer 810 may include, but are not limited to, a processing unit 820 (which can comprise processor 124, 186 or 190), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 a computer system that provides search functionality relative to people in an organization. The computer system includes a processor and a data store containing profile information relative to the people in the organization. A query processing engine is coupled to the processor and is configured to execute queries against the data store. The processor is configured to receive user input information indicative of a name and responsively generate a first query. The query processing engine is configured to execute the first query against only a name field relative to the profile information and return a first query result. The query processing engine is configured to selectively, automatically execute a second query against at least one additional field of the profile information if the first query result is empty, and return second query results.

Example 2 is the computer system of any or all previous examples wherein a characteristic of the user is used to generate the second query.

Example 3 is the computer system of any or all previous examples wherein the at least one additional field includes a short profile field.

Example 4 is the computer system of any or all previous examples wherein the short profile field includes organizational position field.

Example 5 is the computer system of any or all previous examples wherein the short profile field includes geographic location field.

Example 6 is the computer system of any or all previous examples wherein the short profile field includes an alias field.

Example 7 is the computer system of any or all previous examples and further comprising a ranking component configured to rank query results based on the characteristic and the at least one additional field.

Example 8 is the computer system of any or all previous examples wherein the ranking is based, at least in part, on organizational proximity between the user and people identified in the query results.

Example 9 is the computer system of any or all previous examples wherein the ranking is based, at least in part, on geographic proximity between the user and people identified in the query results.

Example 10 is the computer system of any or all previous examples wherein the query processing engine is further configured to selectively automatically execute a third query against all fields of the profile information if the second query result is empty, and return third query results.

Example 11 is the computer system of any or all previous examples and further comprising a ranking component configured to rank query results based on a characteristic of the user and at least one of the fields of the profile.

Example 12 is the computer system of any or all previous examples wherein the profile information includes at least one field selected from the group of fields consisting of a skills field, a tasks field, an experience field, an education field, an interests field, and a certifications field.

Example 13 a computer system that provides search functionality relative to people in an organization. The computer system includes a processor and a data store containing profile information relative to the people in the organization. A query processing engine is coupled to the processor and is configured to execute the query against the profile information in the data store and return a query result. A ranking component is configured to rank query results based on similarity between a characteristic of the user and the at least one non-name field in the profile information.

Example 14 is the computer system of any or all previous examples wherein the non-name field comprises an organizational position field.

Example 15 is the computer system of any or all previous examples wherein the non-name field comprises a geographical location field.

Example 16 is the computer system of any or all previous examples wherein the non-name field comprises a plurality of field including the geographical location field and an organizational position field.

Example 17 is a computer-implemented method of identifying people in an organization. The method includes receiving an input and executing a first query using the input against only a full name field in a database containing profile information of the people in the organization. A second query is selectively, automatically executed using the input against a plurality of fields in the database if the first query does not provide any results.

Example 18 is the computer-implemented method of any or all previous examples and further comprising selectively, automatically executing a third query against all field in the database is the second query does not provide any results.

Example 19 is the computer-implemented method of any or all previous examples and further comprising ranking query results based on proximity between a characteristic of a user that provided the name input and a non-name field in the database.

Example 20 is the computer-implemented method of any or all previous examples wherein the non-name field includes an organizational position field.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system that provides search functionality relative to people in an organization, the computer system comprising:
a processor;
a data store containing profile information relative to the people in the organization;
a query processing engine coupled to the processor and configured to execute queries against the data store;
wherein the processor is configured to receive user input information indicative of a name and responsively generate a first query;
wherein the query processing engine is configured to execute the first query against only a name field relative to the profile information and return a first query result; and
wherein the query processing engine is configured to selectively automatically execute a second query against at least one additional field of the profile information if the first query result is empty, and return second query results.

2. The computer system of claim 1, wherein a characteristic of the user is used to generate the second query.

3. The computer system of claim 1, wherein the at least one additional field includes a short profile field.

4. The computer system of claim 3, wherein the short profile field includes organizational position field.

5. The computer system of claim 3, wherein the short profile field includes geographic location field.

6. The computer system of claim 3, wherein the short profile field includes an alias field.

7. The computer system of claim 2, and further comprising a ranking component configured to rank query results based on the characteristic and the at least one additional field.

8. The computer system of claim 7, wherein the ranking is based, at least in part, on organizational proximity between the user and people identified in the query results.

9. The computer system of claim 7, wherein the ranking is based, at least in part, on geographic proximity between the user and people identified in the query results.

10. The computer system of claim 1, wherein the query processing engine is further configured to selectively automatically execute a third query against all fields of the profile information if the second query result is empty, and return third query results.

11. The computer system of claim 10, and further comprising a ranking component configured to rank query results based on a characteristic of the user and at least one of the fields of the profile.

12. The computer system of claim 10, wherein the profile information includes at least one field selected from the group of fields consisting of a skills field, a tasks field, an experience field, an education field, an interests field, and a certifications field.

13. A computer system that provides search functionality relative to people in an organization, the computer system comprising:
a processor configured to receive user input information indicative of a name and responsively generate a query;
a data store containing profile information relative to the people in the organization;
a query processing engine coupled to the processor and configured to execute the query against the profile information in the data store and return a query result;
a ranking component configured to rank query results based on similarity between a characteristic of the user and the at least one non-name field in the profile information.

14. The computer system of claim 13, wherein the non-name field comprises an organizational position field.

15. The computer system of claim 13, wherein the non-name field comprises a geographical location field.

16. The computer system of claim 15, wherein the non-name field comprises a plurality of field including the geographical location field and an organizational position field.

17. A computer-implemented method of identifying people in an organization, the method comprising:
receiving an input;
executing a first query using the input against only a full name field in a database containing profile information of the people in the organization; and
selectively, automatically executing a second query using the input against a plurality of fields in the database if the first query does not provide any results.

18. The computer-implemented method of claim 17, and further comprising selectively, automatically executing a third query against all field in the database is the second query does not provide any results.

19. The computer-implemented method of claim 17, and further comprising ranking query results based on proximity between a characteristic of a user that provided the name input and a non-name field in the database.

20. The computer-implemented method of claim 19, wherein the non-name field includes an organizational position field.
